(19) United States
(12) Patent Application Publication
(10) Pub. No.: US 2026/0120305 A1
(43) Pub. Date: Apr. 30, 2026

(54) ILLUMINATION DEVICE AND SENSOR DEVICE FOR GENERATING 3-D DATA

(71) Applicant: Marelli Germany GmbH, Reutlingen (DE)

(72) Inventor: Wolfgang HOßFELD, Gomaringen (DE)

(21) Appl. No.: 19/363,087

(22) Filed: Oct. 20, 2025

(30) Foreign Application Priority Data
Oct. 24, 2024 (DE) 102024131071.5

(51) Int. Cl. G06T 7/521; G01B 11/25; H04N 13/239; H04N 13/254

(52) U.S. Cl. CPC G06T 7/521; G01B 11/2545; H04N 13/239; H04N 13/254; G06T 2207/10028; G06T 2207/30252

(57) ABSTRACT

An illumination device is provided, comprising: at least one light source for generating at least one first intermediate light distribution, which in particular comprises only light that is not visible to humans; at least one collimator for generating at least one second intermediate light distribution as a function of the first intermediate light distribution; at least one pattern-generating element for generating at least one third intermediate light distribution as a function of the second intermediate light distribution, wherein the at least one pattern-generating element has a pattern with regions of higher light transmission and regions of reduced light transmission; and at least one projection optics for generating a structured emitted light distribution as a function of the third intermediate light distribution.

### CROSS-REFERENCE TO RELATED APPLICATION

This application claims priority pursuant to 35 U.S.C. 119(a) to German Patent Office Application No. 102024131071.5, filed October 24, 2024, which application is incorporated herein by reference in its entirety.

### BACKGROUND

3-D sensors such as LIDAR or radar sensors are often very expensive and limited in resolution and range.

### SUMMARY

The problems underlying the invention are solved by an illumination device according to Claim 1 and by a sensor device according to a coordinate claim.

One aspect of the description concerns the following subject matter: an illumination device, wherein the illumination device comprises: at least one light source for generating at least one first intermediate light distribution, which in particular comprises only light that is not visible to humans; at least one collimator for generating at least one second intermediate light distribution as a function of the first intermediate light distribution; at least one pattern-generating element for generating at least a third intermediate light distribution as a function of the second intermediate light distribution, wherein the at least one pattern-generating element has a pattern with regions of higher light transmission and regions of reduced light transmission; and at least one projection optics for generating a structured emitted light distribution as a function of the third intermediate light distribution.

This example concerns a projection system for improving passive stereo image processing. In particular, the example relates to a system that comprises the illumination device, which device is used to project a specific projection pattern onto a scene to improve depth measurement and object detection in various areas of application.

The proposed illumination device can provide a cost-effective and at the same time reliable 3-D sensor for a motor vehicle, which can achieve a range of >100 m at night while maintaining high resolution, to provide early detection of, for example, pedestrians, lost cargo on the road, trucks standing crossways across the road, or other obstacles. This is realized by a stereo camera system comprising at least one illumination device. The proposed illumination device improves the accuracy and reliability of the 3-D data acquired by the overall system. This is achieved by the emitted light distribution causing the scene in front of the vehicle to be illuminated with light and dark pixels.

This separation is advantageous because it allows common and therefore cost-effective masks or pattern-generating elements to be used to generate the pattern on the scene, and there is no dark, unlit regions between the bright pixels in which the cameras would not record a usable signal.

An advantageous example is distinguished in that the illumination device comprises: at least one first module comprising the at least one light source, the at least one collimator, the at least one pattern-generating element, and the at least one projection optics, in particular in the at least one pattern-generating element, the regions with reduced light transmission being opaque to light; and at least one second module comprising at least one further light source and at least one further projection optics for emitting an unstructured emitted light distribution comprising in particular only light that is not visible to humans, the structured emitted light distribution and the unstructured emitted light distribution overlapping at least in portions.

Advantageously, the first module emits structured light distribution, which is overlaid by the unstructured light distribution. This means that the regions in the emitted pattern that are not illuminated by the first module are overlaid by the unstructured, possibly homogeneous, emitted light distribution. This means that the entire scene is illuminated and there are no "black spots," i.e., unlit regions of the scene. Rather, a structured pattern is placed over the scene, which improves the recognition of the scene, and particularly the 3-D recognition of the scene.

An advantageous example is distinguished in that the illumination device comprises: a module, in particular a single module, comprising the at least one light source, the at least one collimator, the at least one pattern-generating element, and the at least one projection optics, in which, in the at least one pattern-generating element, the regions with reduced light transmission are light-transparent.

Advantageously, it is thereby possible to use a single module to apply a pattern to the scene in which each pixel or region is illuminated by the single module.

An advantageous example is distinguished in that the projection optics associated with the pattern-generating element comprises an anamorphic lens.

The anamorphic lens can produce an elliptical emitted light distribution, which is advantageous in motor vehicle applications for illuminating the region in front of the vehicle. In other words, the projector's illumination field can be widened, which is advantageous for illuminating and detecting objects in the surrounding environment in road traffic. The collimation optics and the round gobo ("GOes Before Optics," "GOes Between Optics," "Graphical Optical Black-Out") can still be used.

An advantageous example is distinguished in that the pattern of at least one pattern-generating element is fixed.

This makes it possible to produce a simple, cost-effective, and yet effectively useful lighting system. The defined pattern also reduces the control and construction effort.

An advantageous example is distinguished in that the pattern of at least one pattern-generating element comprises rectangles with higher light transmission and rectangles with reduced light transmission.

The pattern thus created based on a regular grid pattern has the advantage of vertical and horizontal edges that can be detected by a sensor between the regions with higher and reduced luminous flux in the emitted light distribution.

An advantageous example is distinguished in that the rectangles of the pattern of the at least one pattern-generating element are larger by a certain factor in a first, in particular vertical, direction perpendicular to the optical axis than in a second, in particular horizontal, direction perpendicular to the optical axis and to the first direction, wherein the anamorphic lens spreads the structured emitted light distribution more strongly in the second direction than in the first direction.

The gobo is therefore designed in such a way that the horizontally and vertically different magnification of the anamorphic lens is compensated for, and the light module produces a light distribution of substantially square pixels, e.g., in conjunction with square individual sensors. This is expedient because cameras usually have square pixels, and therefore an optimal lighting pattern also consists of square pixels.

An advantageous example is distinguished in that the pattern of the at least one pattern-generating element has been generated by Hamming codes and/or simulated annealing.

Hamming codes are designed to ensure a maximum Hamming distance between the codes. This means that the blocks differ greatly from each other in the projection pattern, reducing the likelihood of stereo matching failing due to similarities between neighboring blocks.

Hamming codes are known for their ability to detect and correct errors. In the context of a projection pattern, this means that, even in the presence of disturbances or distortions due to phase noise or blur, the pattern remains robust, and the stereo camera can still find reliable matches.

By using Hamming codes in the projection pattern, the probability of dropouts is significantly reduced, since the strong differences between the blocks allow for precise depth measurement.

Simulated annealing enables an efficient optimization of the projection pattern. This ensures that the pattern is not only theoretically optimal but also remains robust under real conditions.

Simulated annealing is an optimization method. In principle, the mask can be generated using a random generator. This can cause problems with depth measurement and robustness. To avoid these problems, a random pattern is first generated. Then, an associated Hamming code is determined for each portion of the pattern, and simulated annealing is used to modify the pattern so that the Hamming distance is maximized.

An advantageous example is distinguished in pattern regions, differing from one another, of the pattern of the at least one pattern-generating element has an increased or maximum dissimilarity.

Another aspect of the description relates to the following subject matter: a sensor device, comprising at least one illumination device according to one of the preceding claims, wherein the illumination device is set up to illuminate a scene with the at least one emitted light distribution; and at least two image sensors which detect at least portions of the scene illuminated by the at least one illumination device.

### BRIEF DESCRIPTION OF THE DRAWINGS

In the drawings:

FIG. 1 shows an illumination device in a perspectival view;

FIGS. 2 and 3 each show an example of the illumination device in a schematic representation;

FIG. 4 shows a pattern-generating element in a plan view of a mask plane;

FIG. 5 shows a sensor device comprising the illumination device in a schematic representation;

FIG. 6 shows a motor vehicle comprising the sensor device according to FIG. 5; and,

FIGS. 7 to 9 each show the example from FIG. 1 in a longitudinal section with differently displayed beam paths.

### DETAILED DESCRIPTION OF THE INVENTION

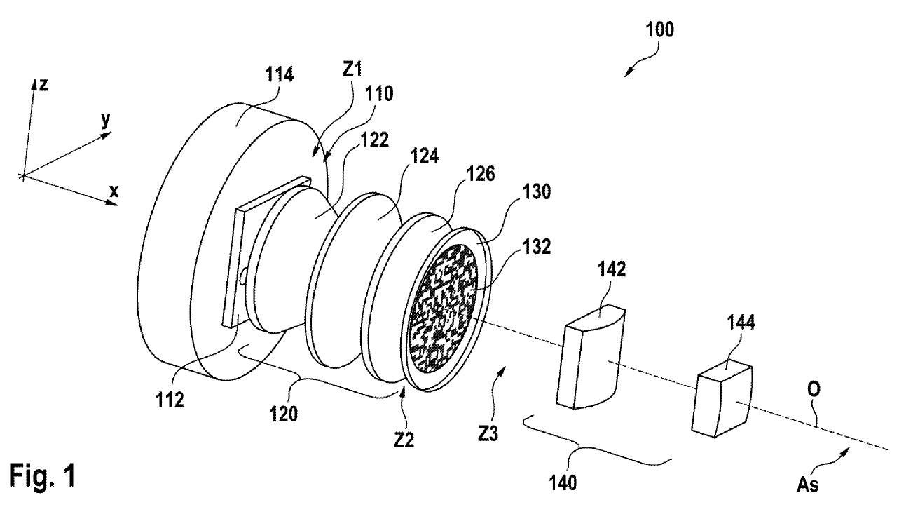

FIG. 1 shows an illumination device 100 in a perspectival view. At least one light source 110 generates at least a first intermediate light distribution Z1, which emits only light that is not visible to humans. At least one light source 110 emits, for example, light in the infrared range. At least one collimator 120 generates at least one second intermediate light distribution Z2 as a function of the first intermediate light distribution Z1. At least one pattern-generating element 130 generates at least one third intermediate light distribution Z3 as a function of the second intermediate light distribution Z2, wherein at least one pattern-generating element 130 has a pattern 132 with regions having higher light transmission and with regions having reduced light transmission compared to the regions having higher light transmission. At least one projection optics 140 generates a structured emitted light distribution As a function of the third intermediate light distribution Z3.

The illumination device 100 of the projection system shown consists of at least one high-power LED or the at least one light source 110, which is designed to generate a projection pattern using at least one pattern-generating element 130. At least one pattern-generating element 130, which contains a defined pattern, is illuminated by at least one light source 110 and projects the pattern onto the scene using projection optics 140. The projected pattern improves the texture of the scene, thus enabling more precise stereo image processing.

At least one light source 110 is pulsed synchronously with the exposure time of the stereo cameras or image sensors to maximize the light intensity and minimize the energy consumption.

At least one light source 110 is arranged on a circuit board 112. The circuit board 112 is arranged on a cooling element 114.

The collimator 120 comprises collimating lenses 122, 124, and 126, which ensure that the diverging light beam of the first intermediate light distribution Z1 is converted into a collimated light beam according to the second intermediate light distribution Z2.

The projection optics 140 associated with the pattern-generating element 130 comprises an anamorphic lens.

The anamorphic lens comprises two lenses 142 and 144 arranged along the optical axis O, wherein their exit surfaces each follow an imaginary cylinder lateral surface, and wherein the imaginary cylinder axes assigned to the cylinder lateral surfaces run perpendicular and spaced apart from one another.

Application in robotics: In robotics, the illumination device 100 enables more precise object detection and manipulation. This allows robots to navigate more accurately and perform complex tasks such as grasping and placing objects more efficiently. The ability to illuminate low-texture regions and eliminate dropouts significantly improves the reliability of robotic systems in variable environments.

Medical applications: In the medical field, the illumination device 100 can be used during minimally invasive surgical procedures, to enable a more accurate visualization of organs and tissue. This improves the accuracy and safety of surgical procedures and supports surgeons when performing complex operations.

Industrial Inspection: In industrial inspection, illumination device 100 is used to detect surface defects and dimensional deviations. The ability to create high-precision 3-D images enables detailed quality control and defect detection, resulting in improved production quality and reduced scrap rates.

Automotive applications: Another area of application of the illumination device 100 is its integration into motor vehicles to improve advanced driver assistance systems (ADAS) and autonomous driving technologies. The illumination device 100 projects an optimized pattern onto the road and the surroundings of the vehicle to enable precise depth measurement and object detection. This supports functions such as the detection of lanes, obstacles, pedestrians, and other vehicles. The system improves the vehicle's safety features by increasing the accuracy and reliability of environment detection. It can also be used for 3-D mapping and creating detailed environmental models, which are essential for navigation and decision-making of autonomous vehicles. The ability to operate reliably even under different lighting conditions and in low-texture environments makes this projection system, in the sense of the illumination device 100, a safety-relevant component of the motor vehicle.

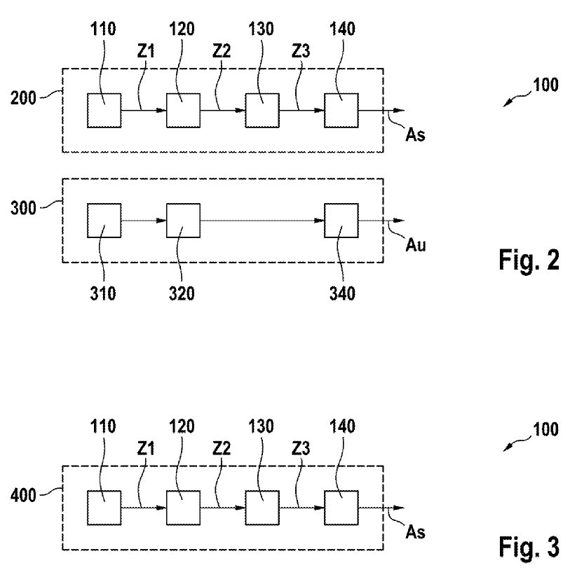

FIG. 2 shows an example of the illumination device 100 in a schematic block diagram. A first module 200 comprises at least one light source 110, the at least one collimator 120, the at least one pattern-generating element 130, and the at least one projection optics 140, wherein, in particular in the at least one pattern-generating element 130, the regions with reduced light transmission are light-opaque.

A second module 300 comprises at least one further light source 310, a further collimator 320, and at least one further projection optics 340 for emitting an unstructured, largely homogeneous, emitted light distribution Au comprising only light that is not visible to humans. The structured light distribution As and the unstructured light distribution Au overlap at least in portions.

Both modules 200, 300 emit infrared light generated by the corresponding light source 110, 310.

The design of the second module 300 can also be realized in different ways, because the optical requirements or image quality are significantly lower compared to the module 200. Thus, the collimator 320 can be replaced by a reflector or a TIR lens.

In both modules 200, 300, the projection optics 140, 340 can also be replaced by at least one free-form reflector or at least one free-form lens or a combination thereof in order to produce an anamorphic image.

For both modules 200 and 300, the horizontal and vertical expansion of the light distribution can also be achieved by a non-rotationally symmetrical design of the collimation optics.

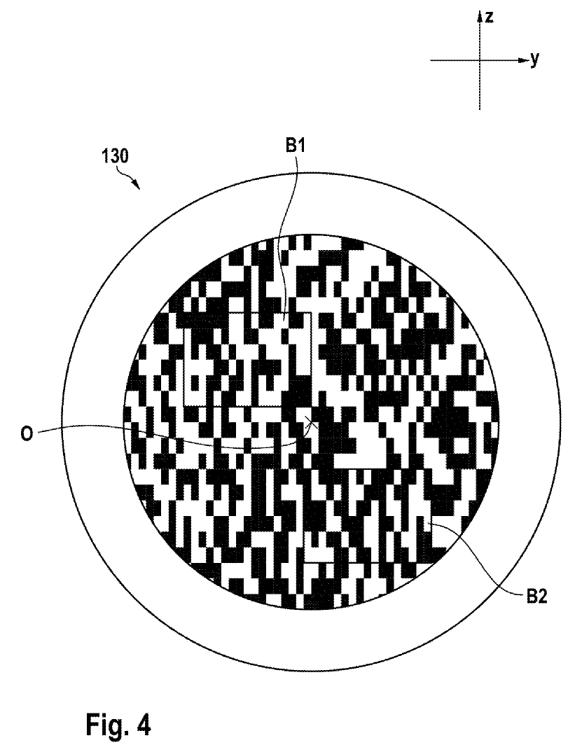

FIG. 3 shows another example of the illumination device 100 in a schematic block diagram. A single module 400 is provided, which comprises: at least one light source 110, at least one collimator 120, the at least one pattern-generating element 130, and the at least one projection optics 140, wherein, in at least one pattern-generating element 130, the regions with reduced light transmission are light-transparent. The structured emitted light distribution as thus comprises pixels with at least two different luminous intensities, which means that no region of the scene remains unlit.

FIG. 4 shows a plan view of the pattern of at least one pattern-generating element 130, which was determined once during production.

The pattern of at least one pattern-generating element 130 comprises rectangles with higher light transmission and rectangles with reduced light transmission. The rectangles of the pattern of the at least one pattern-generating element 130 are larger by a certain factor in a first, in particular vertical, direction z perpendicular to the optical axis O than in a second, in particular horizontal, direction y perpendicular to the optical axis O and the first direction z, wherein the anamorphic lens spreads the structured emitted light distribution As more strongly in the second direction y than in the first direction z. In this way, the factor can be compensated for, and square pixels are generated in the emitted light distribution As. In the example shown in FIG. 1, the light exit surface of the lens 142 is more strongly curved than the light exit surfaces of the lens 144.

The pattern of at least one pattern-generating element 130 has been generated by Hamming codes and/or simulated annealing (SA) in conjunction with Hamming codes.

Simulated annealing (SA) is based upon the principle of the cooling process of a metal, in which the material is heated to a high temperature and then slowly cooled, to bring the atoms into an energetically optimal configuration. This method is described as a search for the global optimum in a solution space. In terms of the pattern, SA typically starts with an initial configuration generated by random algorithms. This initial configuration is used as a starting point, to iteratively modify and optimize the pattern.

The optimization process involves step-by-step changes to the pattern, which is defined by a neighborhood function. This neighborhood function determines which parts of the pattern shall be changed, and the quality of the new configuration is evaluated using a target function that measures the desired result. A crucial role is played by temperature control, which influences the probability of accepting poorer patterns during optimization. Initially, the temperature is high to allow the algorithm to explore suboptimal solutions and avoid local minima. Over time, the temperature decreases, reducing the probability of accepting worse solutions.

The neighborhood function is determined using a Hamming distance, which is determined for a specific part of the pattern. If this Hamming distance is too low, the part of the pattern being examined is modified to increase the Hamming distance. The target function evaluates the Hamming distance of the entire pattern.

In this case, simulated annealing thus uses the neighborhood function, which examines specific parts of the pattern by determining the Hamming distance. The Hamming distance measures the number of positions at which two patterns differ. This method allows the algorithm to make targeted changes in regions of the pattern that require correction. Determining the Hamming distance refines the optimization process by identifying regions that can potentially be improved without changing the overall pattern too strongly. These targeted modifications are crucial for efficiently analyzing the pattern and changing it towards an optimal solution.

The algorithm evaluates each changed pattern in comparison with the previous configuration by means of an energy function. Improved patterns are accepted, while worse ones may be accepted with a probability that depends upon the current temperature. This mechanism helps to analyze and change the pattern efficiently. The goal is to find a configuration that meets the requirements of the predefined Hamming distance and is in a globally optimal state.

The exemplary pattern shown is not generated according to Hamming codes or simulated annealing but is merely a pseudo-random pattern for illustration purposes.

Pattern regions B1, B2 of the pattern of at least one pattern-generating element 130 that differ from one another have an increased or maximum dissimilarity.

The pattern of at least one pattern-generating element 130 is designed as a regular grid of black and white rectangles and is optimized by using Hamming codes and simulated annealing. This optimization ensures maximum dissimilarity between the blocks in the search region, reducing the probability of dropouts and increasing the accuracy of depth measurement. The pattern takes phase noise and system uncertainty into account to ensure high precision even under real-world conditions.

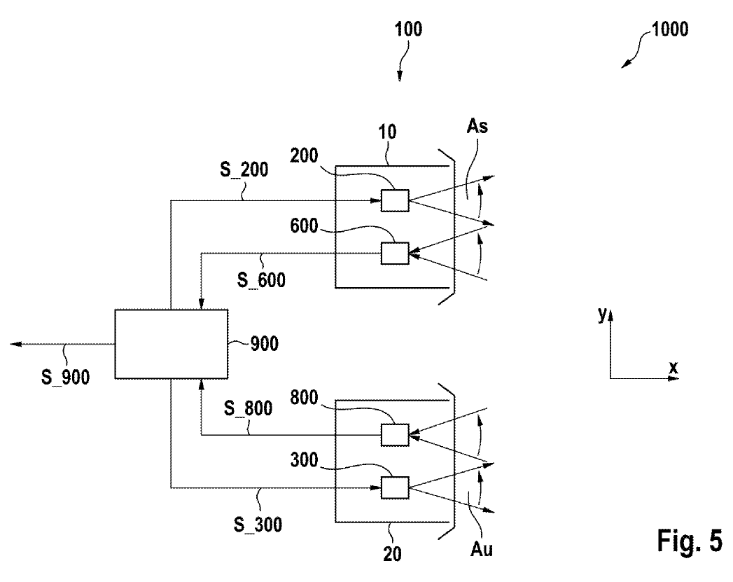

FIG. 5 shows an example of a sensor device 1000. This device comprises at least one illumination device 100 for illuminating a scene with the at least one emitted light distribution As, Au.

At least two image sensors 600, 800 detect, at least in portions, the scene illuminated by the at least one illumination device 100.

In the example of FIG. 5, the illumination device 100 is divided into two units 10 and 20, according to the example of FIG. 2. The units 10 and 20 each comprise a housing in which the corresponding components are arranged. Each housing is closed with a transparent cover plate. The unit 10 comprises the module 200 and the image sensor 600. The unit 20, which is spaced apart from the unit 10, comprises the module 300 and the image sensor 800. A control unit 900 generates signals S_200 and S_300, to cause simultaneous radiation of the beam light distributions As and Au. The illuminated scene is recorded by the image sensors 600, 800 and transmitted to the control unit 900 as image signals S_600 and S_800. The control unit 900 determines an item of scene information as a function of the image signals S_600 and S_800 and outputs it according to a signal S_900. The scene information can, for example, include a generated 3-D image of the scene, i.e., three-dimensional data or 3-D data, or the image signals S_600 and S_800 for further processing. The scene information thus represents a 3-D relief of the scene observed by the sensor device 1000.

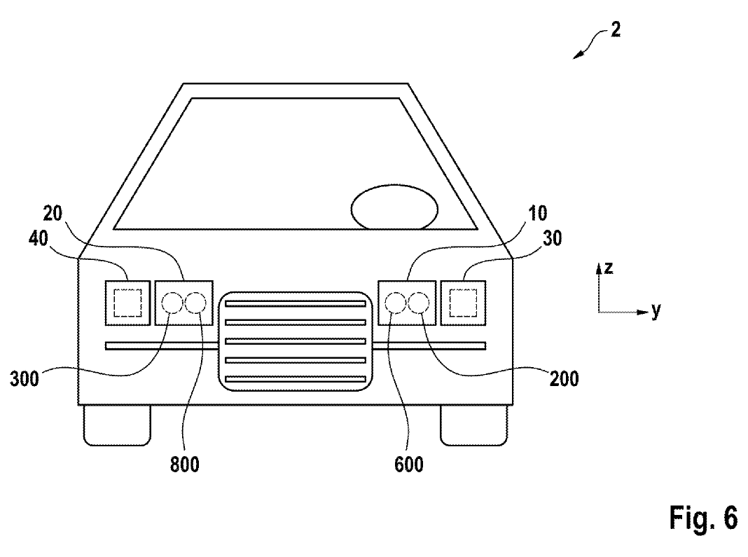

FIG. 6 shows an example of a schematically illustrated front of a motor vehicle 2. The units 10 and 20 are arranged, by way of example, adjacent to the respectively associated headlights 30 and 40. In particular, the units 10 and 20 are arranged, starting from the headlights 30 and 40, in the direction of the vehicle's central longitudinal axis.

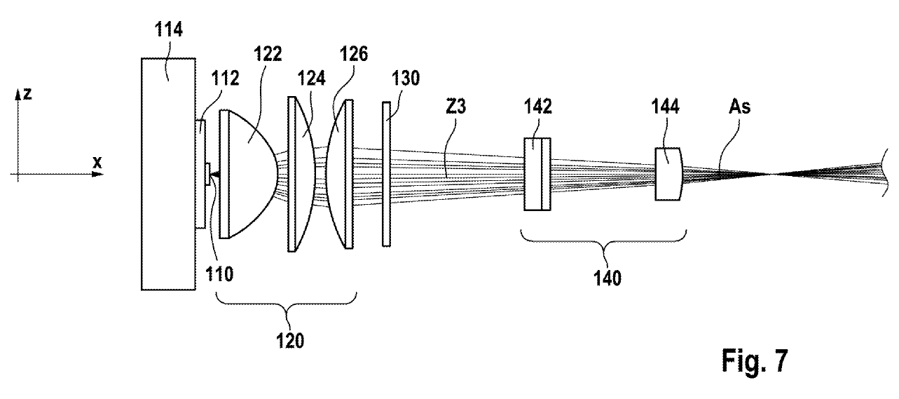

FIG. 7 shows the path of the rays through the illumination device. The collimation optics or collimation lenses 122, 124, 126 focus the light emitted by the light source 110 in such a way that the mask or pattern of the pattern-generating element 130 is illuminated, and the light is then captured by the projection optics 140.

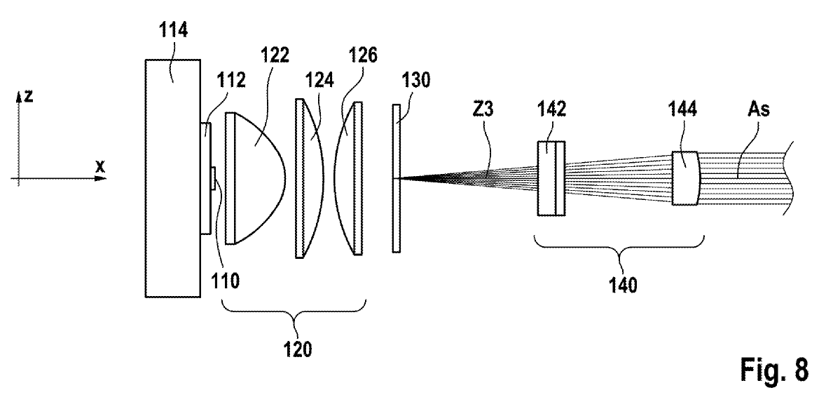

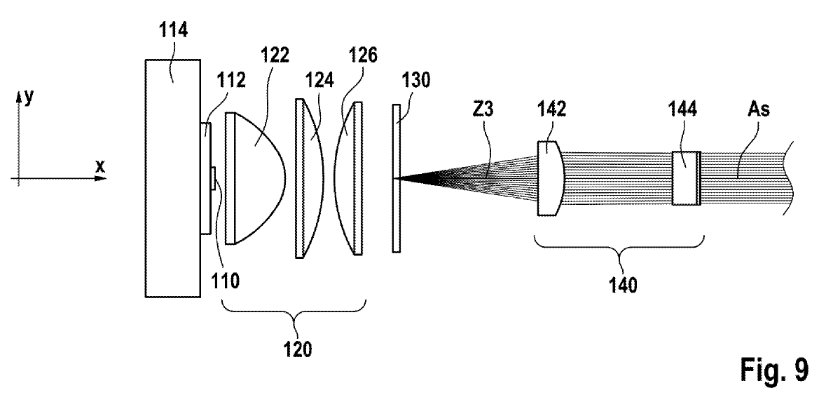

The projection lenses 142 and 144 are two cylindrical lenses that are positioned crosswise to each other. The lens 142 has a curvature only in a horizontal section, while the lens 144 has a curvature only in a vertical section. As a result, the rays emanating from the plane of the mask of the pattern-generating element 130 are converged in a horizontal plane only by the lens 142 (see FIG. 8), and, in the vertical plane, the rays are converged only by the lens 144 (see FIG. 9).

This creates a projection with different magnifications, horizontally and vertically. In the case shown, the horizontal magnification is greater than the vertical magnification because the focal length is smaller in the horizontal plane than in the vertical plane. From the circular light distribution in the mask plane of the pattern-generating element 130, the anamorphic lens forms an elliptical light distribution.

An elliptically shaped light distribution is advantageous for use in object detection in road traffic, since, on the one hand, there are many objects to the left and right of the roadside, and, on the other, these objects still need to be illuminated when driving around curves.

To generate square pixels in the light distribution emitted by the illumination device 100, the pattern on the mask is compressed by a certain factor. An example of such a pattern is shown in FIG. 4. In this case, the pixel pattern has been compressed horizontally by a factor of 2. The distribution of pixels is determined, for example, by a random algorithm.

What is claimed is:

1. An illumination device, wherein the illumination device comprises:
at least one light source for generating at least one first intermediate light distribution, which in particular comprises only light that is not visible to humans;
at least one collimator for generating at least one second intermediate light distribution as a function of the first intermediate light distribution;
at least one pattern-generating element for generating at least one third intermediate light distribution as a function of the second intermediate light distribution, wherein the at least one pattern-generating element has a pattern with regions of higher light transmission and with regions of reduced light transmission; and,
at least one projection optics for generating a structured emitted light distribution as a function of the third intermediate light distribution.

2. The illumination device according to claim 1, wherein the illumination device comprises:
at least one first module comprising the at least one light source, the at least one collimator, the at least one pattern-generating element, and the at least one projection optics, wherein, in particular in the at least one pattern-generating element, the regions with reduced light transmission are light-opaque; and,
at least one second module comprising at least one further light source and at least one further projection optics for emitting an unstructured emitted light distribution comprising, in particular, only light that is not visible to humans, wherein the structured emitted light distribution (As) and the unstructured emitted light distribution overlap at least in portions.

3. The illumination device according to claim 1, wherein the illumination device comprises:
a module, in particular a single module, comprising the at least one light source, the at least one collimator, the at least one pattern-generating element, and the at least one projection optics, wherein, in the at least one pattern-generating element, the regions with reduced light transmission are light-transparent.

4. The illumination device according to claim 1, wherein the projection optics associated with the pattern-generating element comprises an anamorphic lens.

5. The illumination device according to claim 1, wherein the pattern of the at least one pattern-generating element is fixed.

6. The illumination device according to claim 1, wherein the pattern of the at least one pattern-generating element comprises rectangles with higher light transmission and rectangles with reduced light transmission.

7. The illumination device according to claim 4, wherein the rectangles of the pattern of the at least one pattern-generating element are larger by a certain factor in a first, in particular vertical, direction perpendicular to the optical axis than in a second, in particular horizontal, direction perpendicular to the optical axis and to the first direction, wherein the anamorphic lens spreads the structured emitted light distribution more strongly in the second direction than in the first direction.

8. The illumination device according to claim 1, wherein the pattern of the at least one pattern-generating element has been generated by Hamming codes and/or simulated annealing.

9. The illumination device according to claim 1, wherein mutually different pattern regions of the pattern of the at least one pattern-generating element have an increased or maximum dissimilarity.

10. A sensor device comprising:
at least one illumination device according to claim 1, wherein the illumination device is set up to illuminate a scene with the at least one emitted light distribution; and,
at least two image sensors which detect at least portions of the scene illuminated by the at least one illumination device.

11. The illumination device according to claim 2, wherein the projection optics associated with the pattern-generating element comprises an anamorphic lens.

12. The illumination device according to claim 3, wherein the projection optics associated with the pattern-generating element comprises an anamorphic lens.

13. The illumination device according to claim 2, wherein the pattern of the at least one pattern-generating element is fixed.

14. The illumination device according to claim 3, wherein the pattern of the at least one pattern-generating element is fixed.

15. The illumination device according to claim 4, wherein the pattern of the at least one pattern-generating element is fixed.

16. The illumination device according to claim 2, wherein the pattern of the at least one pattern-generating element comprises rectangles with higher light transmission and rectangles with reduced light transmission.

17. The illumination device according to claim 3, wherein the pattern of the at least one pattern-generating element comprises rectangles with higher light transmission and rectangles with reduced light transmission.

18. The illumination device according to claim 4, wherein the pattern of the at least one pattern-generating element comprises rectangles with higher light transmission and rectangles with reduced light transmission.

19. The illumination device according to claim 5, wherein the pattern of the at least one pattern-generating element comprises rectangles with higher light transmission and rectangles with reduced light transmission.
